(19) United States
(12) Patent Application Publication
(10) Pub. No.: US 2024/0191688 A1
(43) Pub. Date: Jun. 13, 2024

(54) Vertical-Axis Wind Turbine Device

(71) Applicant: Jeffrey Smith, Layton, UT (US)

(72) Inventor: Jeffrey Smith, Layton, UT (US)

(21) Appl. No.: 18/161,916

(22) Filed: Jan. 31, 2023

Related U.S. Application Data
(60) Provisional application No. 63/430,843, filed on Dec. 7, 2022.

(51) Int. Cl. F03D 3/04; F03D 3/00; F03D 9/25

(52) U.S. Cl. CPC F03D 3/0427; F03D 3/005; F03D 9/25; F03D 3/065

(57) ABSTRACT

The present invention relates to a vertical-axis wind turbine device comprised of at least one housing with at least one vertical wall and a turbine with at least one base, at least one generator, and at least one blade. The housing is positioned around the turbine, wherein the vertical wall of the housing directs air from around the housing and into the curved blade of the turbine. This allows the turbine to gather air more efficiently and generate power more effectively.

### CROSS-REFERENCE TO RELATED APPLICATION

The present application claims priority to, and the benefit of, U.S. Provisional Application No. 63/430,843, which was filed on Dec. 7, 2022, and is incorporated herein by reference in its entirety.

### FIELD OF THE INVENTION

The present invention relates generally to the field of wind turbines. More specifically, the present invention relates to a vertical-axis wind turbine device comprised of at least one housing with at least one vertical wall and a turbine with at least one base, at least one generator, and at least one blade. The housing is positioned around the turbine, wherein the vertical wall of the housing directs air from around the housing and into the curved blade of the turbine. This allows the turbine to gather air more efficiently and generate power more effectively. Accordingly, the present disclosure makes specific reference thereto. Nonetheless, it is to be appreciated that aspects of the present invention are also equally applicable to other like applications, devices, and methods of manufacture.

### BACKGROUND

Most wind turbines in use today are horizontal-axis wind turbines. Horizontal-axis wind turbines produce more electricity than vertical-axis wind turbines. However, horizontal-axis turbines may be undesirable as they do not produce electricity well in turbulent winds. In addition, horizontal-axis turbines rotate much faster than vertical-axis wind turbines. As a result, birds often cannot see horizontal-axis wind turbines spinning and unknowingly fly into the blades of the turbine. Furthermore, the placement of horizontal-axis wind turbines must be so precious as to optimize the wind flowing over the blades at the proper angle to maximize power generation.

Therefore, there exists a long-felt need in the art for an improved wind turbine. There also exists a long-felt need in the art for an improved vertical-axis wind turbine device. More specifically, there exists a long-felt need in the art for a vertical-axis wind turbine device that offers better production in turbulent winds. There also exists a long-felt need in the art for a vertical-axis wind turbine device that has a reduced risk of bird strikes. In addition, there exists a long-felt need in the art for a vertical-axis wind turbine device that can generate power from all wind angles and wind positions.

The subject matter disclosed and claimed herein, in one embodiment thereof, comprises a vertical-axis wind turbine device. The device is comprised of at least one housing with at least one vertical wall and a turbine with at least one base, at least one generator, and at least one blade. The housing is positioned around the turbine, wherein the vertical wall of the housing directs air from around the housing and into the blade of the turbine. This allows the turbine to gather air more efficiently and generate power more effectively. To further optimize the performance of the turbine, each blade may be curved.

In this manner, the vertical-axis wind turbine device of the present invention accomplishes all the foregoing objectives and provides an improved wind turbine that offers better production in turbulent winds than horizontal-axis turbines. The device also has a reduced risk of bird strikes due to the size of the housing. Due to the shape of the housing and structure of the turbine, the device can also generate power from all wind angles and wind positions.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vertical-axis wind turbine device. The device is comprised of at least one housing with at least one vertical wall and a turbine with at least one base, at least one generator, and at least one blade. The generator is positioned on or within the base. The generator generates electricity when the blades of the turbine are spun via wind. At least one central shaft is attached to the base and/or generator. The central shaft is connected to at least one blade via at least one attachment member such that when wind spins the blade, the shaft spins which provides power to the generator.

The blade is comprised of a curved, rectangular or square, concave shape. The concave shape of the blade allows for maximal force to be generated when wind hits the blade and also ensures the blade rotates at maximum speed. The degree of curvature of the blade may be any degree of curvature less than 180 degrees but is preferably more than 90 degrees but less than 180 degrees.

The device is also comprised of a housing, wherein the turbine sits within the housing. The housing may attach to the base via at least one support. The housing is comprised of a top wall and a parallel bottom wall. At least one vertical wall is attached to the bottom surface of the top wall and the top surface of the bottom wall. In the preferred embodiment, the housing has a plurality of spaced-apart vertical walls that create a plurality of openings. The walls may be positioned at any spacing, any angle, and may have any thickness.

The openings between the walls facilitate air to pass through the housing and into each blade to efficiently spin each blade. The circular shape of the housing allows the openings to direct air into the blades from all directions, making the device more versatile than horizontal-axis wind turbines and more optimized. The housing also protects the turbine from turbulent winds by breaking up turbulent winds and funneling the wind to each blade efficiently. In addition, the size of the housing provides a better opportunity for birds to avoid flying into the device.

Accordingly, the vertical-axis wind turbine device of the present invention is particularly advantageous as it provides an improved wind turbine that offers better production in turbulent winds than horizontal-axis turbines. The device also has a reduced risk of bird strikes due to the size of the housing. Due to the shape of the housing and structure of the turbine, the device can also generate power from all wind angles and wind positions. In this manner, the vertical-axis wind turbine device overcomes the limitations of existing horizontal-axis wind turbines known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vertical-axis wind turbine device of the present invention in accordance with the disclosed architecture;

FIG. 2 illustrates a top perspective view of one potential embodiment of a vertical-axis wind turbine device of the present invention in accordance with the disclosed architecture; and

FIG. 3 illustrates a top view of one potential embodiment of a vertical-axis wind turbine device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved wind turbine. There also exists a long-felt need in the art for an improved vertical-axis wind turbine device. More specifically, there exists a long-felt need in the art for a vertical-axis wind turbine device that offers better production in turbulent winds. There also exists a long-felt need in the art for a vertical-axis wind turbine device that has a reduced risk of bird strikes. In addition, there exists a long-felt need in the art for a vertical-axis wind turbine device that can generate power from all wind angles and wind positions.

The present invention, in one exemplary embodiment, is comprised of a vertical-axis wind turbine device comprised of at least one housing with at least one vertical wall and a turbine with at least one base, at least one generator, and at least one blade. The generator is positioned on or within the base and generates electricity when the blades of the turbine are spun via wind. At least one central shaft is attached to the base and/or generator. The central shaft is connected to at least one blade via at least one attachment member such that when wind spins the blade, the shaft spins which provides power to the generator.

The blade is comprised of a curved, rectangular or square, concave shape that allows for maximal force to be generated when wind hits the blade and also ensures the blade rotates at maximum speed. The degree of curvature of the blade may be any degree of curvature less than 180 degrees. However, the degree of curvature is preferably more than 90 degrees but less than 180 degrees.

The device is also comprised of a housing, wherein the turbine sits within the housing and wherein the housing may attach to the base via at least one support. The housing is comprised of a top wall and a parallel bottom wall. At least one vertical wall is attached to the bottom surface of the top wall and the top surface of the bottom wall. In the preferred embodiment, the housing has a plurality of spaced-apart vertical walls that create a plurality of openings. The walls may be positioned at any spacing, any angle, and may have any thickness.

The openings between the walls facilitate air to pass through the housing and into each blade to efficiently spin each blade. The circular shape of the housing allows the openings to direct air into the blades from all directions making the device more versatile than horizontal-axis wind turbines and more optimized. The housing also protects the turbine from turbulent winds by breaking up turbulent winds and funneling the wind to each blade efficiently. In addition, the size of the housing provides a better opportunity for birds to avoid flying into the device.

Accordingly, the vertical-axis wind turbine device of the present invention is particularly advantageous as it provides an improved wind turbine that offers better production in turbulent winds than horizontal-axis turbines. The device also has a reduced risk of bird strikes due to the size of the housing. Due to the shape of the housing and structure of the turbine, the device can also generate power from all wind angles and wind positions. In this manner, the vertical-axis wind turbine device overcomes the limitations of existing horizontal-axis wind turbines known in the art.

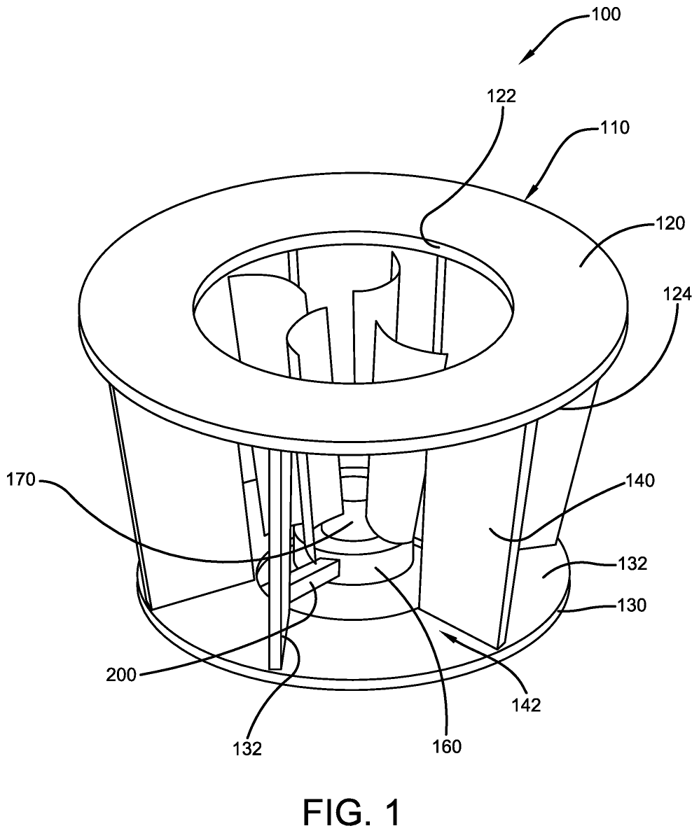

Referring initially to the drawings, FIG. 1 illustrates a perspective view of one potential embodiment of a vertical-axis wind turbine device 100 of the present invention in accordance with the disclosed architecture. The device 100 is comprised of at least one housing 110 with at least one vertical wall 140 and a turbine 150 with at least one base 160, at least one generator 170, and at least one blade 190. The turbine 150 is comprised of a base 160. The base 160 may be any height, weight, and shape. At least one generator 170 is positioned on or within the base 160. The generator 170 generates electricity when the blades 190 of the turbine 150 are spun via wind. The generator 170 may be any generator type (including associated components) known in the art of wind turbines.

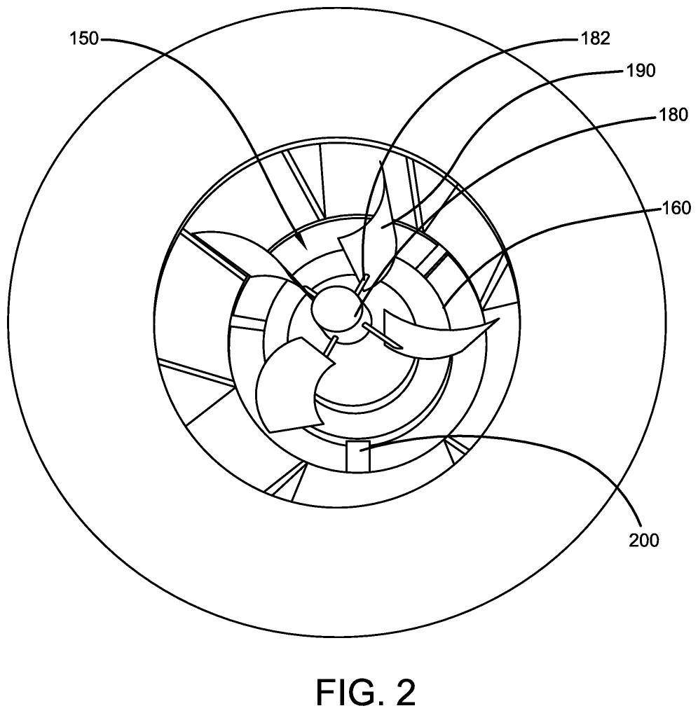

At least one central shaft 180 is attached to the base 160 and/or generator 170. The central shaft 180 is connected to at least one blade 190 via at least one attachment member 182 that is preferably horizontal, as seen in FIG. 2. When wind spins the blade 190, the shaft 180 spins which provides power to the generator 170 to allow the generator 170 to generate electricity.

The blade 190 is comprised of a curved, rectangular or square, concave shape. The concave shape of the blade 190 allows for maximal force to be generated when wind hits the blade 190 and also ensures the blade 190 rotates at maximum speed. The degree of curvature of the blade 190 may be any degree of curvature less than 180 degrees. However, the degree of curvature is preferably more than 90 degrees but less than 180 degrees. The blade 190 may be any height and any shape that allows for efficient energy generation.

The device 100 is also comprised of a housing 110. The turbine 150 sits within the housing 110. The housing 110 may attach to the base 160 via at least one support 200. The support 200 may be any attachment method known in the art.

The housing 110 is comprised of a top wall 120 and a parallel bottom wall 130. Each wall 110,130 is preferably circular in shape. Each wall 120,130 may also be comprised of at least one opening 122,132 that allows air to enter the device 100 from the top and the bottom of the device 100. Alternatively, each wall 120,130 may have no opening.

At least one vertical wall 140 is attached to the bottom surface 124 of the top wall 120 and the top surface 134 of the bottom wall 130. In the preferred embodiment, the housing 110 has a plurality of spaced-apart vertical walls 140 that create a plurality of openings 142. The walls 140 may be positioned at any spacing, any angle, and may have any thickness.

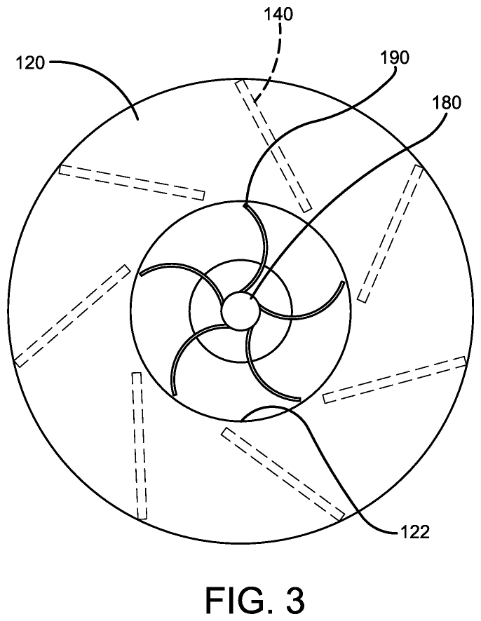

The openings 142 between the walls 140 facilitate air to pass through the housing 110 and into each blade 190 to efficiently spin each blade 190, as can be seen in FIG. 3. The circular shape of the housing 110 allows the openings 142 to direct air into the blades 190 from all directions (i.e., 360 degrees) making the device 100 more versatile than horizontal-axis wind turbines and more optimized. In addition, the size of the housing 110 provides a better opportunity for birds to avoid flying into the device 100.

The housing 110 also protects the turbine 150 from turbulent winds. To do so, the walls 140 of the housing 110 break up turbulent winds and funnel the wind to each blade 190 efficiently. In the preferred embodiment, the device 100 has more walls 140 than blades 190 to provide more angles so that wind can be funneled to the blades 190 as they spin.

Any component of the device 100 may be made from any wind turbine material known in the art. This includes, but is not limited to, fiberglass, resin, plastic, iron, cast iron, copper, aluminum, steel, polyester, epoxy, alloy, glass, carbon fiber, carbon, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vertical-axis wind turbine device” and “device” are interchangeable and refer to the vertical-axis wind turbine device 100 of the present invention.

Notwithstanding the foregoing, the vertical-axis wind turbine device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vertical-axis wind turbine device 100 as shown in the FIGS. are for illustrative purposes only, and that many other sizes and shapes of the vertical-axis wind turbine device 100 are well within the scope of the present disclosure. Although the dimensions of the vertical-axis wind turbine device 100 are important design parameters for user convenience, the vertical-axis wind turbine device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vertical-axis wind turbine device comprising:
a housing comprised of a top wall, a bottom wall and a vertical wall; and
a turbine comprised of a base, a generator, a central shaft, and a blade.

2. The vertical-axis wind turbine device of claim 1, wherein the blade is comprised of a curved blade.

3. The vertical-axis wind turbine device of claim 1, wherein the turbine is positioned within the housing.

4. The vertical-axis wind turbine device of claim 1, wherein the top wall is parallel to the bottom wall.

5. The vertical-axis wind turbine device of claim 1, wherein the generator is positioned within the base.

6. The vertical-axis wind turbine device of claim 1, wherein the housing is comprised of a circular shaped housing.

7. A vertical-axis wind turbine device comprising:
a housing comprised of a top wall, a bottom wall, and a vertical wall; and
a turbine positioned within the housing, wherein the turbine comprised of a base, a generator, a central shaft, an attachment member and a blade.

8. The vertical-axis wind turbine device of claim 7, wherein the blade attaches to the central shaft via the attachment member.

9. The vertical-axis wind turbine device of claim 7, wherein the blade has a degree of curvature less than 180 degrees.

10. The vertical-axis wind turbine device of claim 7, wherein the generator is positioned on the base.

11. A vertical-axis wind turbine device comprising:
a housing comprised of a top wall, a bottom wall, a vertical wall and a support; and
a turbine positioned within the housing, wherein the turbine comprised of a base, a generator, a central shaft, an attachment member, and a blade.

12. The vertical-axis wind turbine device of claim 11, wherein the housing attaches to the base via the support.

13. The vertical-axis wind turbine device of claim 11, wherein the blade is comprised of a convex shape.

14. The vertical-axis wind turbine device of claim 13, wherein a degree of curvature of the blade is between 90 and 179 degrees.

15. The vertical-axis wind turbine device of claim 11, wherein the top wall is comprised of a first opening.

16. The vertical-axis wind turbine device of claim 11, wherein the bottom wall is comprised of a second opening.

17. The vertical-axis wind turbine device of claim 11, wherein the generator is an electrical generator.

18. The vertical-axis wind turbine device of claim 11, wherein the housing is comprised of a circular shaped housing.

19. The vertical-axis wind turbine device of claim 11, wherein the blade is comprised of a fiberglass, a resin, a plastic, an iron, a cast iron, a copper, an aluminum, a steel, a polyester, an epoxy, an alloy, a glass, a carbon fiber, or a carbon material.

20. The vertical-axis wind turbine device of claim 11, wherein the housing is comprised of a fiberglass, a resin, a plastic, an iron, a cast iron, a copper, an aluminum, a steel, a polyester, an epoxy, an alloy, a glass, a carbon fiber, or a carbon material.
